(19) United States
(12) Patent Application Publication
(10) Pub. No.: US 2019/0116762 A1
(43) Pub. Date: Apr. 25, 2019

(54) LEASH EXTENSION WITH HANDLE

(71) Applicant: Mark Litzsinger, Lake Forest, IL (US)

(72) Inventor: Mark Litzsinger, Lake Forest, IL (US)

(21) Appl. No.: 16/227,603

(22) Filed: Dec. 20, 2018

Related U.S. Application Data
(60) Provisional application No. 62/613,156, filed on Jan. 3, 2018.

(51) Int. Cl. A01K 27/00

(52) U.S. Cl. CPC A01K 27/003; A01K 27/005

(57) ABSTRACT

A leash extension has a main body and two loops at opposite ends of the main body. One loop connects one or more leashes to one end of the leash extension. The other end has a handle that receives the other loop. The handle has a slot for receiving the loop. The user can easily grasp and hold the handle which provides the secure grasping means so that the user must only grasp the handle in order to walk one or more animals simultaneously.

### CROSS-REFERENCE TO RELATED APPLICATION

This application is based on and claims priority of provisional patent application Ser. No. 62/613,156 filed Jan. 3, 2018.

### FIELD OF THE INVENTION

The present invention relates to a leash grip and leash extension and, more particularly, to a single leash extension with an improved handle for connecting multiple leashes to a pet. The leash extension accommodates walking multiple dogs or other domestic pets at the same time on multiple leashes using this single leash extension.

### BACKGROUND AND SUMMARY OF THE INVENTION

Pet owners and dog walkers have oftentimes had to walk several pets at the same time. The problem is that when walking several pets it becomes difficult to hold the leash in one hand, especially if the dog walker is walking several large and strong pets. If one of the larger and stronger dogs suddenly tries to run after something, and the walker has several leashes in one hand, it is possible for the leash to slip out of the walker's grip and the dog can run away. The problem is exasperated when the person is walking more and more dogs simultaneously.

Applicant's invention provides a simple, safe, secure and convenient means for the walker to hold multiple leashes in one hand. The leash extension has two loops. One loop connects one or more leashes to the distal end of the leash extension. One or more carabiners are connected to the distal end for receiving separate leashes attached to the dogs. The proximal end has a handle that receives the larger loop. The user can easily grasp and hold the handle which provides the secure grasping means so that multiple leashes can be attached to the distal end while the user must only grasp the handle at the proximal end of the leash extension.

### BRIEF DESCRIPTION OF THE DRAWINGS

The Description of the Preferred Embodiment will be better understood with reference to the following figures:

FIG. 1 is a top perspective view of Applicant's leash extension invention.

FIG. 2 is a top perspective exploded view of Applicant's leash extension invention and, in particular, illustrating the handle, rope, and combiner.

FIG. 3 is a bottom perspective view of the rope of Applicant's leash extension invention and, in particular, illustrating the first loop, second loop, and anchoring harness to the main section of the rope.

FIG. 4 is a bottom perspective view of the carabiner in Applicant's leash extension invention.

FIG. 5 is an end perspective view of the handle in Applicant's leash extension invention.

FIG. 6 is a side perspective view of the handle in Applicant's leash extension invention and, in particular, illustrating the finger indentations for grasping by the user.

FIG. 7 is a top perspective exploded view of a first alternate embodiment of Applicant's leash extension invention.

FIG. 8 is a top perspective view of a second alternate embodiment of Applicant's leash extension invention.

### DETAILED DESCRIPTION OF THE PREFERRED EMBODIMENT

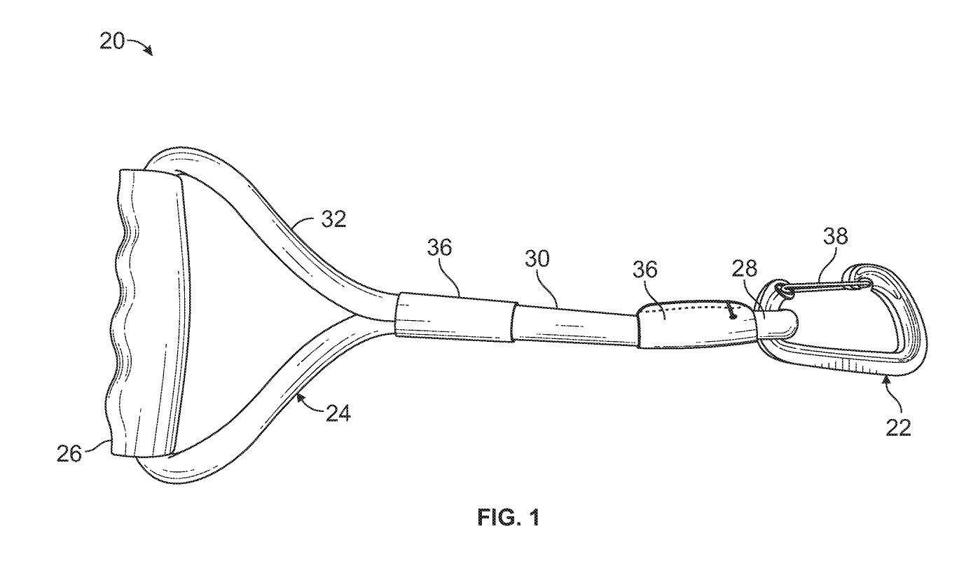

Turning first to FIG. 1, there is illustrated Applicant's inventive leash extension 20. In the preferred embodiment, the leash extension 20 comprises a carabiner 22, a rope 24, and a handle 26.

The carabiner 22 is a loop with a spring-loaded gate or opening 38 used to quickly and reversibly connect components. The carabiner 22 is preferably made of metal such as steel or aluminum. An enlarged view of the carabiner 22 is illustrated in FIG. 4. Alternatively, in lieu of a carabiner 22, it is contemplated that any other type of attachment means may be used, including but not limited to, a shackle (i.e., a U-shaped piece of metal secured with a clevis pin or bolt across the opening, or a hinged metal loop secured with a quick-release locking pin mechanism), or any other attachment means known to one skilled in the art.

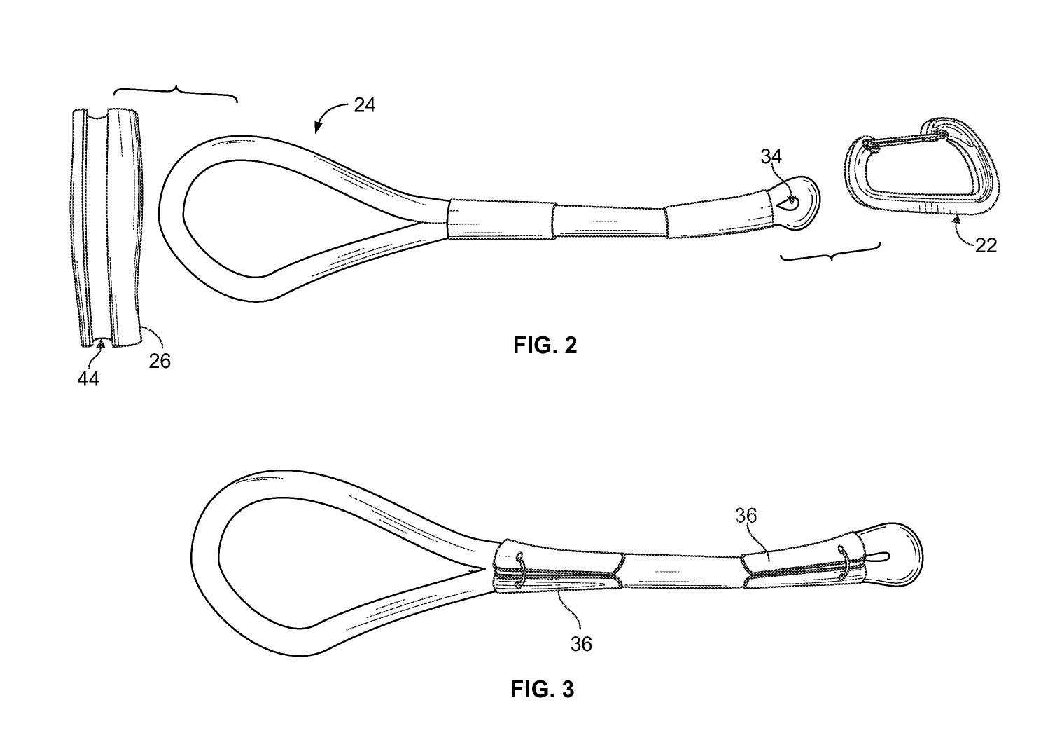

The rope 24 is separated into a main section 30, an integrated first loop 28, situated at the distal end, and an integrated second loop 32, situated on the proximal or opposite end. The main section 30 is preferably a single intertwined rope made of any webbing known to one skilled in the art. The first loop 28 provides a first loop opening 34 (FIG. 2) that is of sufficient diameter to be releasably connected through the spring-loaded gate or opening 38 of the carabiner 22. The second loop 32 forms the rope handle designed to be grasped by the hand of the user. An anchoring harness 36 (see also FIG. 3) is used to strengthen the connection of the main section 30 at the location where the main section 30 is formed into each of the first loop 28 and second loop 32.

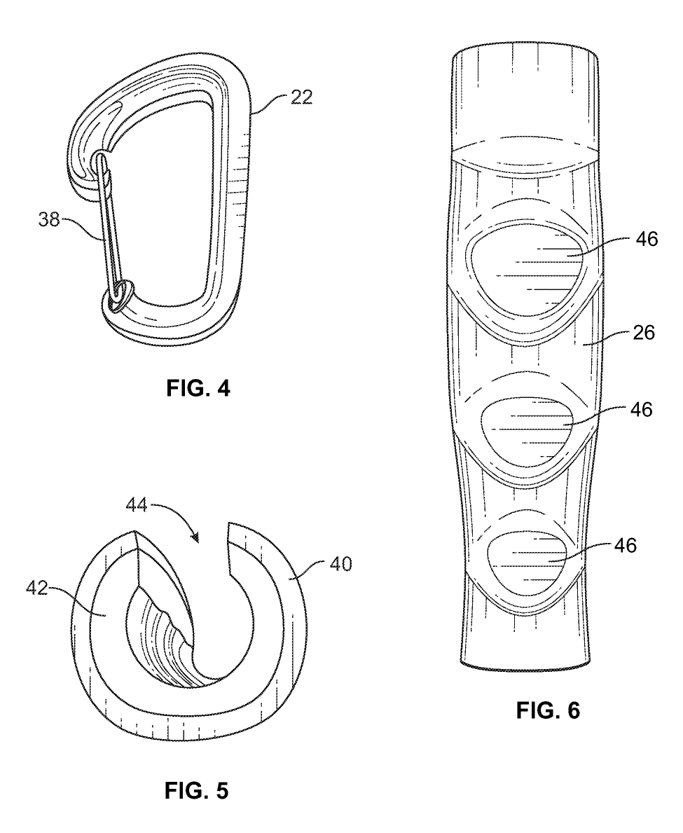

The handle 26 is releasably connected to the second loop 32. This allows the user to grip the handle 26 instead of the rope of the second loop 32. This prevents rope burns and provides the user a secure and comfortable gripping means for holding the second loop 32. As illustrated in FIG. 5, the handle 26 is designed with an ergonomic curvilinear body 40 formed with an interior surface 42. An elongated slot 44 is provided from the proximal end to the distal end of the handle 26 for creating an opening to receive the second loop 32. The width of the elongated slop 44 should be a width to receive the thickest diameter of the rope 24 of the second loop 32. In the preferred embodiment, the ergonomic curvilinear body 40 formed with the interior surface 42 are integrally molded together and made of a durable hard plastic material. Alternatively, the curvilinear body 40 formed with the interior surface 42 may be assembled and made of any material known to one skilled in the art.

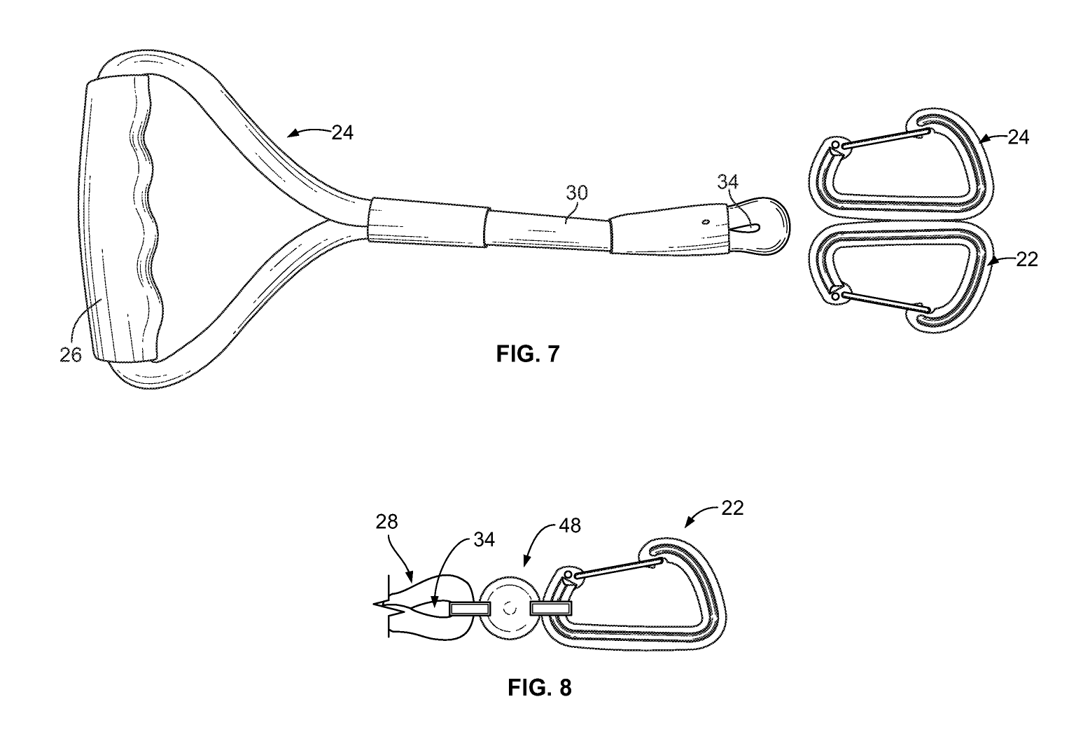

When the handle 26 is in use, the second loop 32 of the rope 24 is inserted into and through the elongated slot 44 for connecting the rope 24 to the handle 26. As illustrated in FIG. 7, the elongated slot 44 is positioned outwardly or in the direction away from the rope 24, with the exterior of the handle 26 located inside the second loop 32 with integrated finger indentations 46 oriented inward to make it easier to grasp and be used by the user.

Applicant's handle 26 can also be used with other types of leashes or ropes. The elongated slot 44 can receive other types of leashes that have a loop at the grasping end of the leash. The rope or leash is inserted into the slot 44. The handle 26 provides an improved means by which the user can securely hold a leash attached to the pet. The force exerted by the pet when pulling on the leash is spread out over the entire handle, making it easy for the pet owner to restrain unwanted movement by the pet.

In a first alternate embodiment, as illustrated in FIG. 7, the first loop opening 34 (FIG. 2) of the first loop 28 of the rope 24 may be of sufficient diameter to be releasably connected to the two carabiners 22 situated adjacent to one another in back-to-back fashion. In this first alternate embodiment, and with an additional carabiner connection, Applicant's inventive leash extension 20 may increase the number of leashes connected and thereby accommodate walking that many more dogs or other domestic pets at the same time using Applicant's single leash extension.

In a second alternate embodiment, as illustrated in FIG. 8, instead of connecting the first loop opening 34 (FIG. 2) of the first loop 28 of the rope 24 directly to the carabiner 22, a rotatable ball hinge 48 may be used in between, to couple or join the rope 24 to the carabiner 22. In this manner, the rotabable ball hinge 48 (i) permits the rotation of the carabiner 22 in all directions to accommodate the movement and direction of the walking dogs or other domestic pets without affecting the rope 24 and grasping by the user; (ii) permits the rotation of the handle 26 and the rope 24 in all directions to accommodate the movement and direction of the user without affecting the carabiner 22 and the walking dogs or other domestic pets; and (iii) permits the rotation of both the carabiner 22 and handle 26 and the rope 24 independent of one another. It is also contemplated that the rotatable ball hinge 48 may be, and use any interior ball bearings or other components, and be connected to the carabiner 22 and rope 24 in any other manner or means as known to one skilled in the art. This ball hinge allows the pets to move in different directions and not tangle the individual leashes.

Thus, there has been provided Applicant's unique leash extension invention. While the invention has been described in conjunction with a specific embodiment, it is evident that many alternatives, modifications and variations will be apparent to those skilled in the art in light of the foregoing description. Accordingly, it in intended to embrace all such alternatives, modifications and variations as fall within the spirit and scope of the disclosure contained herein.

What is claimed is:

1. A leash extension device for pets comprising:
a flexible main body having a proximal end and a distal end,
a handle having a length with an elongated slot from one end of the handle to the other,
a looped rope connected to the proximal end,
the handle receiving the looped rope through the elongated slot, and
the distal end having a second looped rope adapted for receiving at least one animal restraining means.

2. The leash extension of claim 1 wherein the handle is cylindrical and has an internal diameter greater than, the diameter of the looped rope.

3. The leash extension of claim 2 wherein the looped rope is integrally formed from the flexible main body.

4. The leash extension of claim 3 wherein the second loop is integrally formed from the flexible main body.

5. The leash extension of claim 1 and further comprising a combiner mounted in the second loop.

6. The leash extension of claim 2 wherein the handle further comprises at least three recessed areas on the side of the handle opposite the slot for grasping by the user.

7. A leash extension device of pets comprising:
a flexible rope comprised of a main body, a first looped end and a second looped end opposite the first looped end,
a rigid handle having a length and a diameter,
a slot along the length of the handle for receiving the first looped end in the slot,
the second looped end receiving at least one animal restraining means.

8. The leash extension of claim 7 wherein the handle is cylindrical and has an internal diameter greater than the diameter of the looped rope.

9. The leash extension of claim 8 wherein the first looped end is integrally formed with the main body.

10. The leash extension of claim 8 wherein the second looped end is integrally formed with the main body.

11. The leash extension of claim 7 and further comprising a carabiner mounted in the second loop.

12. The leash extension of claim 7 wherein the handle further comprises at least three recessed areas on the side of the handle opposite the slot for grasping by the user.
